(19) United States
(12) Patent Application Publication
(10) Pub. No.: US 2010/0257948 A1
(43) Pub. Date: Oct. 14, 2010

(54) Eccentric Load Compensated Load Cell

(75) Inventor: Nils Aage Juul Eilersen, Vedbaek (DK)

Correspondence Address: COHEN, PONTANI, LIEBERMAN & PAVANE LLP, 551 FIFTH AVENUE, SUITE 1210, NEW YORK, NY, 10176, US

(73) Assignee: Siemens AG, München (DE)

(21) Appl. No.: 12/738,585

(22) PCT Filed: Oct. 16, 2008
(86) PCT No.: PCT/DK08/00366

§ 371 Date: Apr. 16, 2010

(30) Foreign Application Priority Data
Oct. 16, 2007 (DK) 200701495

(51) Int. Cl. G01L 1/14

(52) U.S. Cl. 73/862.626

(57) ABSTRACT

A capacitive load cell with an integral membrane and mechanically coupled conductive surfaces, deflected by the load, and mounted each side of an electrode carrier, where conductive electrodes are mounted on each side of the electrode carrier to face the mechanically coupled conductive surfaces to thereby form two or more sensor capacitances.

### CROSS-REFERENCE TO RELATED APPLICATIONS

This is a U.S. national stage of International Application No. PCT/DK2008/000366, filed on 16 Oct. 2008. Priority is claimed on Denmark Application No. PA2007 01495, filed on 16 Oct. 2007.

### BACKGROUND OF THE INVENTION

1. Field of the Invention

The invention relates to load cells and, more particularly, to a load cell for measuring mechanical loads and forces comprising an elastic body fitted with sensors for measuring the deflection of a membrane loaded by the load or force to be measured.

2. Description of the Related Art

The load cell shown in FIG. 1 is a well known design for measuring compression forces or loads.

Here, the normally cylindrical elastic load cell body 1 is placed with the rim 2 on a supporting structure and the load is applied to a membrane 3 through a load button 4 at the top of the load cell.

An insulating electrode carrier 5 is mounted in a cavity 6 of the load cell body 1 by way of elastic supports 7.

In conjunction with the lower side of the membrane 3, a conductive layer 8 applied at the electrode carrier 5 forms a sensor capacitance which changes value when the membrane 3 is deflected by the load or force to be measured.

An electronic module 9 converts the sensor capacitance to a signal which is brought to the outside of the load cell through a cable conduit.

The cavity 6 of the load cell is closed by another membrane 10.

In conventional designs, the signal from the sensor measuring the deflection or the strain will be different from the correct value when the load is applied eccentrically or when the load has a force component which is not parallel to the axis of the load cell.

### SUMMARY OF THE INVENTION

It is therefore an object of the invention to provide capacitive load cells having electrodes which are arranged to compensate for eccentric loads or loads applied at an angle to the axis of the load cell.

This and other objects and advantages are achieved in accordance with the invention by arranging mechanically coupled conductive surfaces, which are deflected by the load or force to be measured, at each side of an electrode carrier produced from insulating material, where conductive electrodes are mounted on each side of the electrode carrier to face the mechanically coupled conductive surfaces to form two or more sensor capacitances.

In preferred embodiments, the mechanically coupled conductive surfaces are provided with means for adjusting the area or the gap of the sensor capacitances.

Consequently, loads and forces applied eccentrically or with an angle to the axis of the load cell may be measured in accordance with the disclosed embodiments with a high degree of accuracy.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The present invention is further described hereinafter with reference to the illustrated embodiments shown in the accompanying drawings, in which:

FIG. 1 shows a known conventional load cell;

FIG. 2 shows a load cell in accordance with the invention;

FIG. 3 shows an insulated electrode carrier with an upper electrode of FIG. 2;

FIG. 4 shows a conventional insulated electrode carrier with a lower electrode of FIG. 2;

FIG. 5 shows an exemplary mechanically coupled conductive surface in accordance with an embodiment of the invention;

FIG. 6 shows an exemplary mechanically coupled conductive surface in accordance with an alternative embodiment of the invention;

FIG. 7 shows an exemplary mechanically coupled conductive surface in accordance with another embodiment of the invention;

FIG. 8 shows an exemplary mechanically coupled conductive surface of FIG. 7 in accordance with a preferred embodiment;

FIG. 9 shows an exemplary mechanically coupled conductive surface in accordance with an alternative preferred embodiment; and

FIG. 10 shows an electrode carrier of a preferred embodiment of the load cell in accordance with the invention, where one or both of its electrode surfaces are divided into two or more sections of electrode areas.

### DETAILED DESCRIPTION OF THE PREFERRED EMBODIMENTS

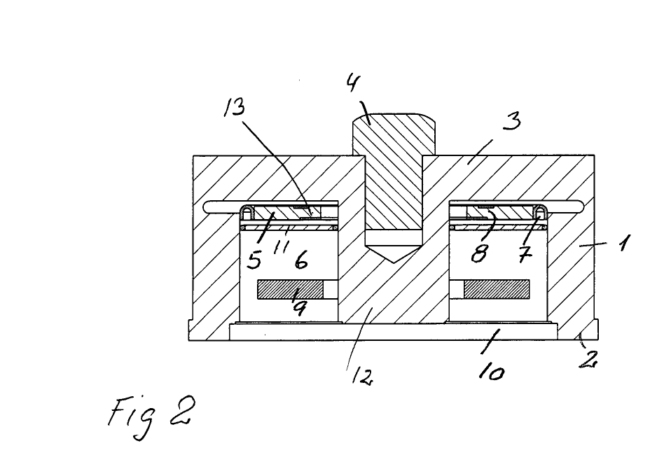

FIG. 2 shows the elements of a load cell with an added conductive surface 11 mechanically coupled to the conductive surface constituted by the lower side of the membrane 3 in accordance with the invention. Here, the coupling is performed by mounting the inner circumference of the conductive surface 11 on the cylindrical part 12 of the elastic body 1.

In the structure depicted in FIG. 2, the outer circumference of the mechanically coupled conductive surface 11 is mounted at the inner wall of the cylindrical part of the elastic body 1. As a result, the deformation of the coupled conductive surface 11 will closely follow the deformation of the membrane 3.

The conductive surface 11 forms a sensor capacitance with the conductive layer 13 which is applied to the lower side of the insulating electrode carrier 5.

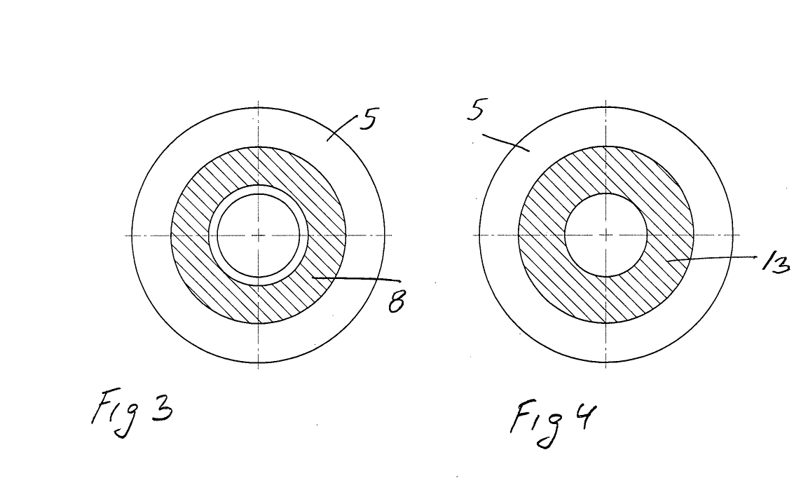

FIG. 3 shows an insulated electrode carrier 5 of FIG. 2 with the upper electrode 8. FIG. 4 shows an insulated electrode carrier 5 of FIG. 2 with the lower electrode 13.

Here, the electrode carrier 5 may preferably be produced of high stability ceramic material, and the electrodes 8 and 13 may preferably be applied as silver electrodes by thick film technology.

The inner and outer diameters of the electrodes 8 and 13 may also be equal or different, but the areas will preferably be concentric with the membrane 3.

These diameters and the distance between the electrode 8 and the membrane 3 and the distance between the electrode 13 and the coupled conductive surface 11 will be chosen as a combination for best linearity of the measurement.

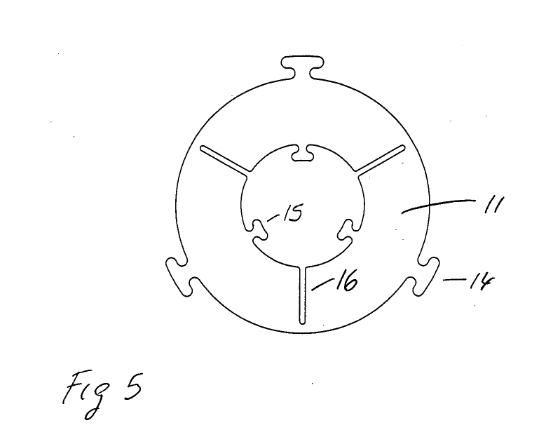

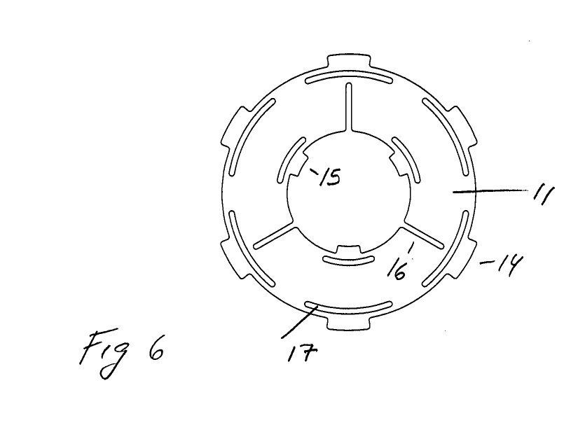

FIG. 5 shows an embodiment of the mechanically coupled conductive surface 11 with a means 14 for mounting the conductive surface 11 to the inner wall of the cylindrical part of the elastic body 1 and a means 15 for coupling the conductive surface 11 to the cylindrical part 12 of the elastic body 1.

The cuts 16 in the coupled conductive surface 11 may tailor the deformation of the conductive surface 11 to enable a suitable relation between the deformation of the membrane 3 and the conductive surface 11.

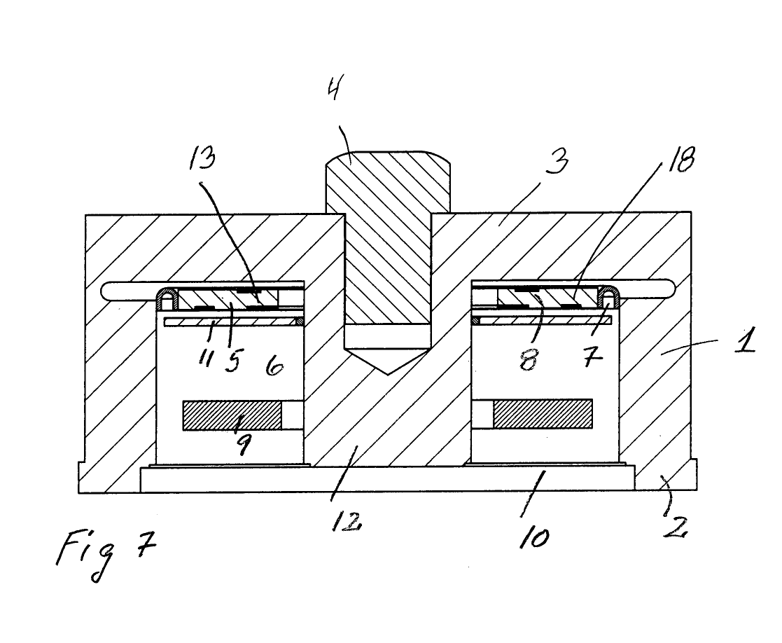

FIG. 6 shows an embodiment of the mechanically coupled conductive surface 11 with the means 14 for mounting the conductive surface 11 to the inner wall of the cylindrical part of the elastic body 1 and the means 15 for coupling the conductive surface 11 to the cylindrical part 12 of the elastic body 1.

Here, the cuts 16 in the coupled conductive surface 11 may also tailor the deformation of the conductive surface 11 to enable a suitable relation between the deformation of the membrane 3 and the conductive surface 11.

Moreover, the cuts 17 permit a difference in the coefficient of thermal expansion between the elastic body 1 and the mechanically coupled conductive surface 11 to be equalized when the ambient temperature changes.

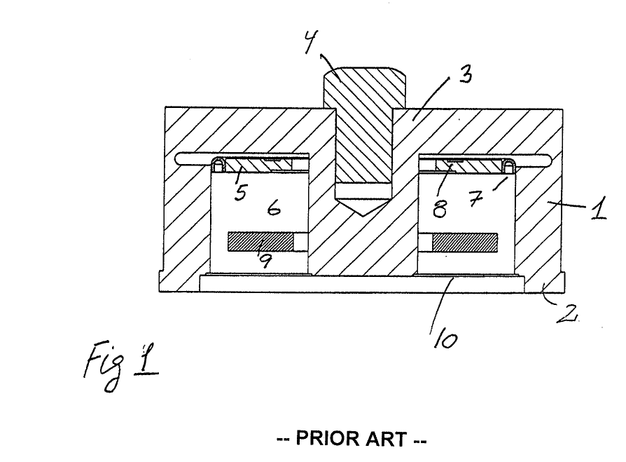

The sensitivity of a capacitive load cell to eccentric loads and forces is due to the non linear relation of the distance between the electrodes of the sensor capacitance and the capacitance. With an eccentric load applied to the conventional load cell of FIG. 1, the membrane will deflect mostly at the side at which the load is applied, and to a lesser degree at the opposite side of the membrane 3.

Because of the nonlinear characteristic of the sensor capacitance, with a higher sensitivity with a smaller distance, the conventional load cell of FIG. 1 will tend to generate a higher signal with an eccentric load.

The disclosed embodiment of the invention shown in FIG. 2, relies on the coupled conductive surface 11 to be deflected in a manner closely matching the deflection of the membrane 3 when eccentrically loaded.

Because the electrodes 8 and 13 are coupled differentially to the capacitance measuring electronic module 9, the effect of the eccentric load is compensated to a high degree.

In certain embodiments, the inner and outer diameters of the electrodes 8 and 13 are tailored to adjust the compensation.

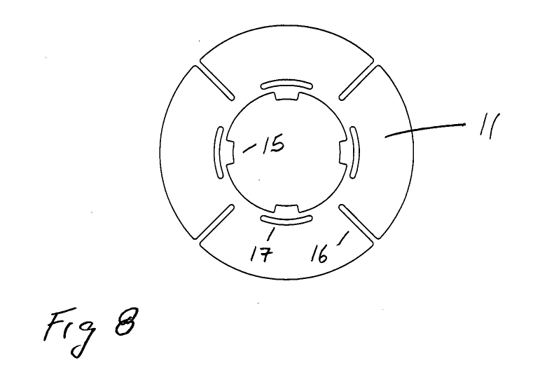

FIG. 7 shows an alternative embodiment of the invention in which the mechanically coupled conductive surface 11 is mounted only at the inner circumference to the cylindrical part 12.

Here, the mechanically coupled conductive surface 11 will follow the movement of the cylindrical part 12, but will not be deformed in the same manner as the membrane 3.

In addition, the mechanically coupled conductive surface 11 will, for centric loads, constitute one part of a differential sensor capacitance together with the electrode 13, and the other part of the differential sensor capacitance will be constituted by the membrane 3 and the electrode 8.

The embodiment of the invention shown in FIG. 7 relies on the coupled conductive surface 11 to be tilted in a manner closely matching the tilting of the membrane 3 when eccentrically loaded.

By tailoring the inner and outer diameters of the electrodes 8 and 13 the compensation can be performed to a high degree of accuracy.

Here, the sensor electrode 18 will be more sensitive to the tilting of the mechanically coupled conductive surface 11 because of the greater distance to the center of the load cell, but will be equally sensitive to the sensor capacitances 8 and 13 for centric loading.

By tailoring the diameters and thus the area of the sensor capacitance 18, it is possible to use this signal in the electronic module to adjust the compensation to eccentric loads.

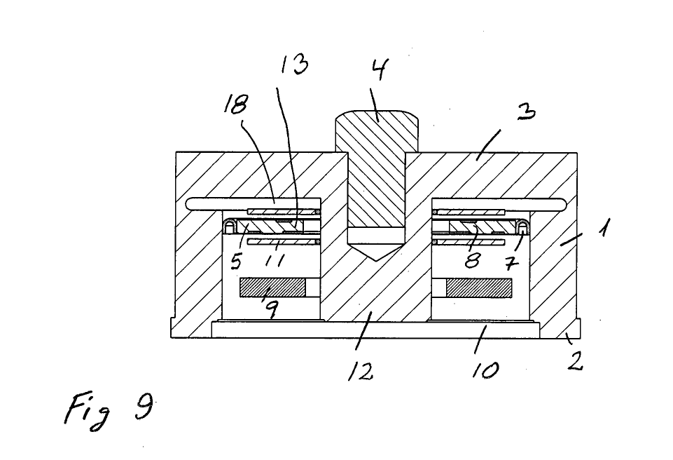

FIG. 8 shows a preferred embodiment of the mechanically coupled conductive surface 11 which is implemented in the device shown in FIG. 7.

Here, the mechanically coupled conductive surface 11 is mounted on the cylindrical part 12 by means 15 for coupling the conductive surface 11 to the cylindrical part 12 of the elastic body, and the cuts 17 enable equalization of differences in the thermal expansion between the conductive surface 11 and the cylindrical part 12 to be equalized.

Here, the cuts 16 enable the four depicted segments of the mechanically coupled conductive surface 11 to have the distance to the sensor capacitances 13 and 18 adjusted individually, simply by bending one or more of them in a suitable manner.

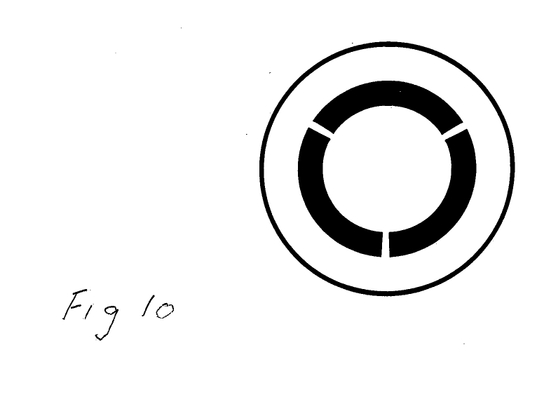

FIG. 9 shows a preferred embodiment of the load cell in accordance with the invention, where one additional mechanically coupled conductive surfaces 18 is placed on the cylindrical part 12 to provide a sensor capacitance with the electrode 8.

In the presently contemplated embodiment, the advantages are achieved by the identical characteristics and deflection of the mechanically coupled conductive surface 11 and the mechanically coupled conductive surface 18.

FIG. 10 shows the electrode carrier of a preferred embodiment of the load cell in accordance with the invention, where one or both of the electrode surfaces 8 and 13 are divided into two or more sections of electrode areas.

In FIG. 10, three sections are shown, and preferably, but not necessarily each section is measured separately by the electronic module 9 (not shown).

Here, the advantages are achieved in the present embodiment due to the possibility to tailor the characteristics of the electrode areas separately.

Due to the fact that preferred embodiments of the invention has been illustrated and described herein, it will be apparent to those skilled in the art that modifications and improvements may be made to forms herein specifically disclosed.

Accordingly, the present invention is not to be limited to the forms specifically disclosed.

For example the number and the position of the mounting means 14 and 15 and the cuts 16 and 17 in the mechanically coupled conductive surface 11 may be varied according to the specific application.

As another example, the electrode carrier itself is not necessarily produced of insulating material, but could be produced of any suitable dimensionally stable material applied with insulated layers or insulated parts to support the capacitive electrodes.

In addition, the lateral groove between the membrane 3 and the load cell body 1 may be tailored to provide a sufficient deformation of the membrane 3 without transferring excessive stresses to the load cell body 1.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-7. (canceled)

8. A load cell comprising:
an elastic body having a cavity;
an integral membrane within the cavity;
an electrode carrier;
capacitance sensors configured to measure a deflection of the membrane when loaded by a load or force to be measured, said capacitance sensors being mounted in a cavity of the elastic body; and
mechanically coupled conductive surfaces, which are deflected by the load or force to be measured, mounted each side of the electrode carrier; and
conductive electrodes mounted on each side of the electrode carrier to face the mechanically coupled conductive surfaces to form a plurality of sensor capacitances.

9. The load cell according to claim 8, wherein the electrode carrier is produced from insulating material.

10. The load cell according to claim 8, wherein one of the mechanically coupled conductive surfaces is an inner surface of the integral membrane of the elastic body and another of the mechanically coupled conductive surfaces is mounted at its inner circumference on a cylindrical part of the load cell body and is mounted at its outer circumference to an inner wall of the cylindrical part of the elastic body.

11. The load cell according to claim 9, wherein one of the mechanically coupled conductive surfaces is an inner surface of the integral membrane of the elastic body and another of the mechanically coupled conductive surfaces is mounted at its inner circumference on a cylindrical part of the load cell body and is mounted at its outer circumference to an inner wall of the cylindrical part of the elastic body.

12. The load cell according to claim 8, wherein one of the mechanically coupled conductive surfaces is an inner surface of the integral membrane of the elastic body and another of the mechanically coupled conductive surfaces is mounted at its inner circumference on a cylindrical part of the load cell body.

13. The load cell according to claim 9, wherein one of the mechanically coupled conductive surfaces is an inner surface of the integral membrane of the elastic body and another of the mechanically coupled conductive surfaces is mounted at its inner circumference on a cylindrical part of the load cell body.

14. The load cell according to claim 8, wherein two mechanically coupled conductive surfaces, one mounted above the electrode carrier and another mounted below the electrode carrier, are mounted at an inner circumference on a cylindrical part of the load cell body.

15. The load cell according to claim 8, wherein two mechanically coupled conductive surfaces, one mounted above the electrode carrier and another mounted below the electrode carrier, are mounted at an inner circumference on a cylindrical part of the load cell body.

16. The load cell according to claim 9, wherein two mechanically coupled conductive surfaces, one mounted above the electrode carrier and another mounted below the electrode carrier, are mounted at an inner circumference on a cylindrical part of the load cell body.

17. Load cell according to claim 8, wherein at least one of said electrode areas mounted on each side of the electrode carrier is divided into a plurality of sections along its circumference.

18. The load cell according to claim 8, wherein at least one of the electrode areas mounted on each side of the electrode carrier is divided into a plurality of sections.
